(19) United States
(12) Patent Application Publication
(10) Pub. No.: US 2014/0118323 A1
(43) Pub. Date: May 1, 2014

(54) ORGANIC LIGHT EMITTING DISPLAY

(71) Applicant: SAMSUNG DISPLAY CO., LTD., Yongin-City (KR)

(72) Inventor: Sung-Cheon PARK, Yongin-City (KR)

(73) Assignee: SAMSUNG DISPLAY CO., LTD., Yongin-City (KR)

(21) Appl. No.: 13/776,801

(22) Filed: Feb. 26, 2013

(30) Foreign Application Priority Data
Oct. 29, 2012 (KR) 10-2012-0120646

(51) Int. Cl. G09G 3/32

(52) U.S. Cl. CPC G09G 3/3291
USPC 345/212; 345/82

(57) ABSTRACT

An organic light emitting display includes: a plurality of pixels coupled to scan lines and data lines; a scan driver that supplies a scan signal to the pixels through the scan lines according to a predetermined scan frequency; a data driver that supplies a data signal to the pixels through the data lines; and a first switching regulator that supplies a first voltage to the pixels and has a changeable switching frequency. In the organic light emitting display, the switching frequency of the first switching regulator is changed while avoiding the scan frequency of the scan driver. Accordingly, it is possible to provide an organic light emitting display which can improve power conversion efficiency and reduce a flicker phenomenon.

### CLAIM OF PRIORITY

This application makes reference to, incorporates the same herein, and claims all benefits accruing under 35 U.S.C. §119 from an application earlier filed in the Korean Intellectual Property Office on the 29 Oct. 2012 and there duly assigned Serial No. 10-2012-0120646.

### BACKGROUND OF THE INVENTION

1. Field of the Invention

The present invention relates to an organic light emitting display, and more particularly, to an organic light emitting display which can improve power conversion efficiency and reduce a flicker phenomenon.

2. Description of the Related Art

Recently, there have been developed various types of displays capable of reducing the weight and volume of cathode ray tubes, which are disadvantages. The displays include a liquid crystal display (LCD), a field emission display (FED), a plasma display panel (PDP), an organic light emitting display (OLED), etc.

Among these displays, the organic light emitting display displays images using organic light emitting diodes that emit light through recombination of electrons and holes. The organic light emitting display has a fast response speed and is driven with low power consumption.

The organic light emitting display includes a power supply that generates and supplies voltages required to drive the organic light emitting display through conversion of external power.

Generally, a switching regulator for DC-DC conversion is widely used as the power supply of the organic light emitting display.

As the organic light emitting display is employed in a mobile device, etc., interest in power conversion efficiency of the power supply increases.

However, there is a problem in that, although the switching frequency of the switching regulator has great influence on the power conversion efficiency of the power supply, the organic light emitting display of the related art is used by fixing the switching frequency of the switching regulator, regardless of load capacity.

Furthermore, as the scan frequency of a scan driver is set without considering the switching frequency of the switching regulator, a flicker phenomenon may occur on a screen.

### SUMMARY OF THE INVENTION

The present invention relates to an organic light emitting display which can improve power conversion efficiency and reduce a flicker phenomenon.

According to an aspect of the present invention, there is provided an organic light emitting display, including: a plurality of pixels coupled to scan lines and data lines; a scan driver that supplies a scan signal to the pixels through the scan lines according to a predetermined scan frequency; a data driver that supplies a data signal to the pixels through the data lines; and a first switching regulator that supplies a first voltage to the pixels and has a changeable switching frequency, the switching frequency of the first switching regulator being changed while avoiding the scan frequency of the scan driver.

The switching frequency of the first switching regulator may be changed while avoiding the scan frequency and a harmonic frequency of the scan frequency.

The first switching regulator may include: a first switching element coupled between a first node and a first input terminal through which an input voltage is applied to the first switching element; a second switching element coupled between the first node and a first output terminal through which the first voltage is outputted; a first inductor coupled between the first node and a ground; and a first switching controller that controls the first and second switching elements according to the switching frequency.

The first switching controller may change the switching frequency by reflecting the first voltage.

The first switching regulator may further include: a control voltage generator that generates a control voltage using the difference between a reference voltage and a feedback voltage reflecting the first voltage; and a voltage controlled oscillator that generates a clock signal having a frequency changed depending on the control voltage.

The first switching controller may control the switching frequency in synchronization with the frequency of the clock signal supplied from the voltage controlled oscillator.

The first switching regulator may further include a voltage divider that generates the feedback voltage by dividing the first voltage of the first output terminal.

The first and second switch elements may be implemented as transistors.

The first voltage may be a negative voltage.

The first and second switching elements may be alternately turned on.

The organic light emitting display may further include a second switching regulator that supplies a second voltage to the pixels.

The second switching regulator may include: a second inductor coupled between a second node and a second input terminal through which the input voltage is applied to the second inductor; a third switching element coupled between the second node and the ground; a fourth switching element coupled between the second node and a second output terminal through which the second voltage is outputted; and a second switching controller that controls the third and fourth switching elements.

The third and fourth switching elements may be implemented as transistors.

The third and fourth switching elements may be alternately turned on.

As described above, according to the present invention, it is possible to provide an organic light emitting display which can improve power conversion efficiency and reduce a flicker phenomenon.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating an organic light emitting display according to an embodiment of the present invention.

FIG. 2 is a circuit diagram illustrating an embodiment of a pixel shown in FIG. 1.

FIG. 3 is a circuit diagram illustrating a power supply according to an embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may not only be directly coupled to the second element but may also be indirectly coupled to the second element via a third element. Furthermore, some of the elements that are not essential to a complete understanding of the invention are omitted for clarity. Also, like reference numerals refer to like elements throughout.

Hereinafter, an organic light emitting display according to an embodiment of the present invention will be described in detail with reference to the accompanying drawings.

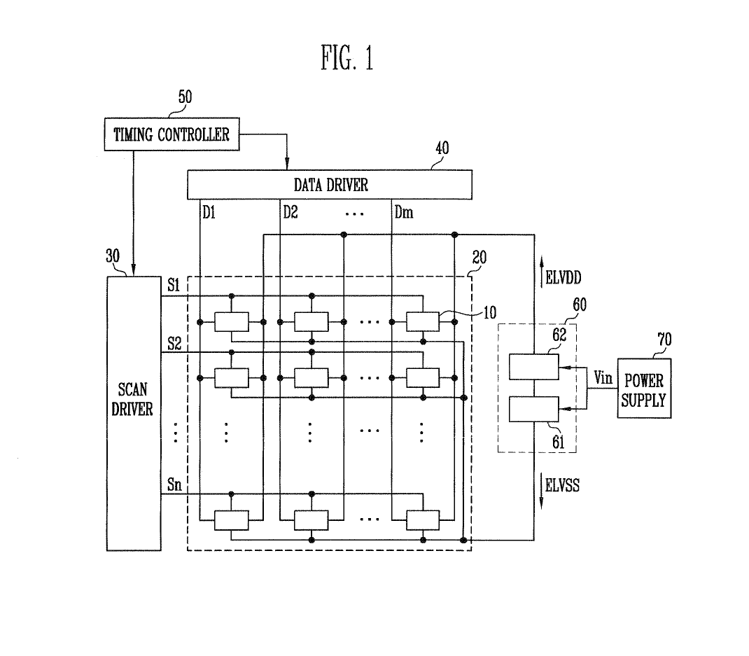

FIG. 1 is a block diagram illustrating an organic light emitting display according to an embodiment of the present invention.

Referring to FIG. 1, the organic light emitting display according to this embodiment includes a pixel unit 20 having a plurality of pixels 10 coupled to scan lines Si to Sn and data lines D1 to Dm, a scan driver 30 that supplies a scan signal to each pixel 10 through the scan lines S1 to Sn, a data driver 40 that supplies a data signal to each pixel 10 through the data lines D1 to Dm, and a power supply 60 that supplies a first voltage ELVSS and a second voltage ELVDD to each pixel 10. The organic light emitting display may further include a timing controller 50 that controls the scan driver 30 and the data driver 40.

Each pixel 10 that receives the first and second voltages ELVSS and ELVDD, respectively, from the power supply 60 may emit light corresponding to a data signal by current flowing from the second voltage ELVDD to the first voltage ELVSS via the organic light emitting diode OLED.

The scan driver 30 generates a scan signal under the control of the timing controller 50, and supplies the generated scan signal to the scan lines S1 and Sn.

In this case, the scan driver 30 may supply the scan signal according to a predetermined scan frequency.

For example, the number of scan lines in an HD or WXGA organic light emitting display is 1280. Thus, in a case where 60 frames are displayed for 1 second, the scan frequency can be set to 76.8 kHz.

The scan frequency of the scan driver 30 may be controlled by the timing controller 50.

The data driver 40 generates a data signal under the control of the timing controller 50, and supplies the generated data signal to the data lines D1 to Dm.

If a scan signal is sequentially supplied to the scan lines S1 to Sn, pixels 10 are sequentially selected for each line. Thus, the selected pixels 10 can receive a data signal supplied from the data lines D1 to Dm.

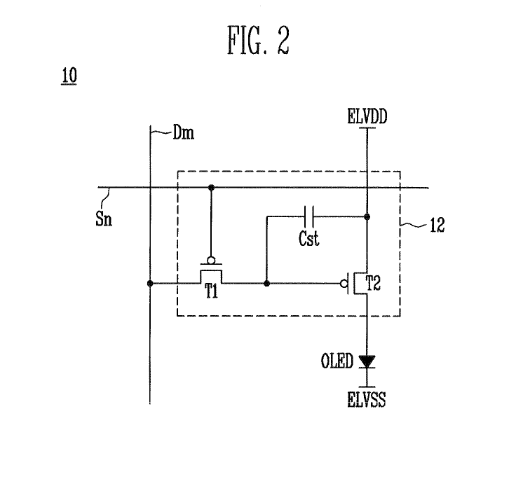

FIG. 2 is a circuit diagram illustrating an embodiment of a pixel shown in FIG. 1. Particularly, for convenience of illustration, a pixel coupled to an n-th scan line Sn and an m-th scan line Dm is shown in FIG. 2.

Referring to FIG. 2, the pixel 10 includes an organic light emitting diode OLED and a pixel circuit 12 coupled to the data line Dm and the scan line Sn so as to control the organic light emitting diode OLED.

An anode electrode of the organic light emitting diode OLED is coupled to the pixel circuit 12, and a cathode electrode of the organic light emitting diode OLED is coupled to the first voltage ELVSS.

The organic light emitting diode OLED generates light with a predetermined luminance, corresponding to current supplied from the pixel circuit 12.

The pixel circuit 12 controls the amount of current supplied to the organic light emitting diode OLED, corresponding to a data signal supplied to the data line Dm when a scan signal is supplied to the scan line Sn. To this end, the pixel circuit 12 includes a second transistor T2 coupled between the second voltage ELVDD and the organic light emitting diode OLED, a first transistor T1 coupled among the second transistor T2, the data line Dm and the scan line Sn, and a storage capacitor Cst coupled between a gate electrode and a first electrode of the second transistor T2.

A gate electrode of the first transistor T1 is coupled to the scan line Sn, and a first electrode of the first transistor T1 is coupled to the data line Dm.

A second electrode of the first transistor T1 is coupled to one terminal of the storage capacitor Cst.

Here, the first electrode is set as any one of source and drain electrodes, and the second electrode is set as an electrode different from the first electrode. For example, if the first electrode is set as a source electrode, the second electrode is set as a drain electrode.

The first transistor T1 coupled to the scan line Sn and the data line Dm is turned on when a scan signal is supplied from the scan line Sn, so as to supply a data signal supplied from the data line Dm to the storage capacitor Cst.

The gate electrode of the second transistor T2 is coupled to the one terminal of the storage capacitor Cst, and the first electrode of the second transistor T2 is coupled to the other terminal of the storage capacitor Cst. A second electrode of the second transistor T2 is coupled to the anode electrode of the organic light emitting diode OLED.

The second transistor T2 controls the amount of current flowing from the second voltage ELVDD to the first voltage ELVSS via the organic light emitting diode OLED, corresponding to the voltage stored in the storage capacitor Cst. In this case, the organic light emitting diode OLED emits light corresponding to the amount of the current supplied from the second transistor T2.

The pixel structure of FIG. 2 described above is merely an embodiment of the present invention, and therefore, the pixel 10 of the present invention is not limited to the pixel structure. Practically, the pixel circuit 12 has a circuit structure capable of supplying current to the organic light emitting diode OLED, and the circuit structure may be selected as any one of various circuit structures currently known in the art.

The power supply 60 of FIG. 1 generates the first and second voltages ELVSS and ELVDD supplied to each pixel 10 by receiving an input voltage Vin inputted from the power supply 70 and converting the input voltage Vin.

Preferably, the first voltage ELVSS is set as a negative voltage, and the second voltage ELVDD is set as a positive voltage.

The power supply 70 may be a battery for providing DC voltage or a rectifier for converting AC voltage into DC voltage and outputting the DC voltage. However, the present invention is not limited thereto.

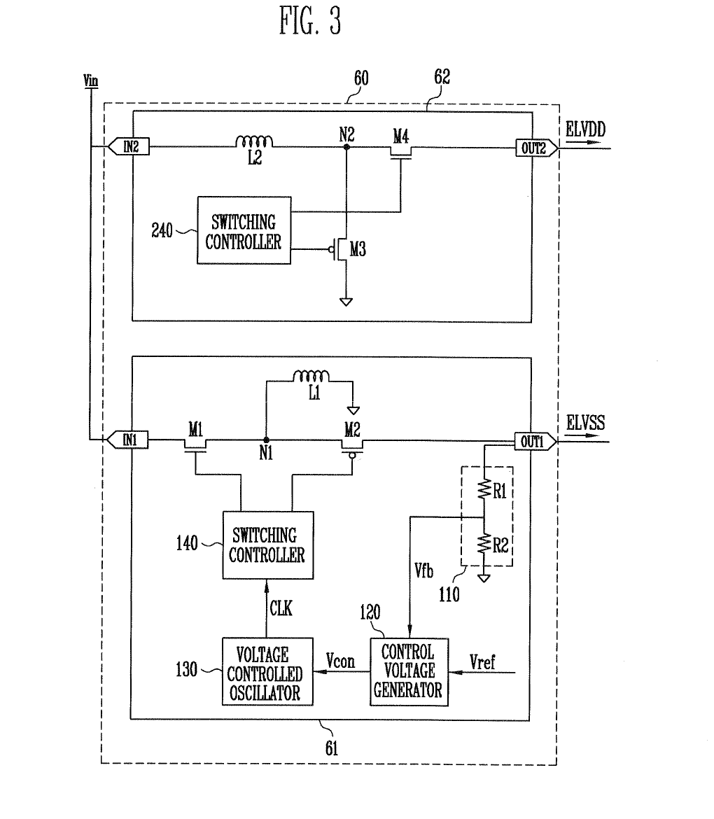

FIG. 3 is a circuit diagram illustrating a power supply according to an embodiment of the present invention.

Referring to FIGS. 1 and 3, the power supply 60 according to this embodiment may include a first switching regulator 61 that generates the first voltage ELVSS from the input voltage Vin, and a second switching regulator 62 that generates the second voltage ELVDD from the input voltage Vin.

The first switching regulator 61 converts the input voltage Vin into the first voltage ELVSS, and supplies the first ELVSS to each pixel 10.

In this case, the switching frequency of the first switching regulator 61 is not fixed to a specific frequency but may be changed.

For example, the first switching regulator 61 may change the switching frequency according to the capacity of a load in order to improve power conversion efficiency.

In a case where the switching frequency of the first switching regulator 61 corresponds to the scan frequency of the scan driver 30, a flicker phenomenon may occur on a screen. Therefore, the switching frequency of the first switching regulator 61 is preferably changed while avoiding the scan frequency of the scan driver 30.

In order to more radically remove the flicker phenomenon, the switching frequency of the first switching regulator 61 is preferably set so as not to overlap with a harmonic frequency of the scan frequency.

For example, when the scan frequency of the scan driver 30 is 76.8 kHz, a second harmonic frequency of the scan frequency may be obtained as 153.6 kHz, and a third harmonic frequency of the scan frequency may be obtained as 230.4 kHz.

Therefore, the switching frequency of the first switching regulator 61 is preferably changed while avoiding not only the scan frequency of the scan driver 30 but also the harmonic frequency of the scan frequency.

For example, the switch frequency of the first switching regulator 61 may be changed into 50 kHz, 100 kHz, 200 kHz, etc. so as not to overlap with the scan frequency and the harmonic frequency.

In this case, information on the scan frequency of the scan driver 30 may be provided from the timing controller 50 to the first switching regulator 61.

Referring to FIG. 3, the first switching regulator 61 may include a first switching element M1, a second switching element M2, a first inductor L1 and a first switching controller 140.

The first switching element M1 may be coupled between a first node N1 and a first input terminal IN1 through which the input voltage Vin is applied to the first switching element M1.

The second switching element M2 may be coupled between the first node N1 and a first output terminal OUT1 through which the first voltage ELVSS is outputted.

The first inductor L1 may be coupled between the first node N1 and a ground.

In this case, the first node N1 may be defined as a common node of the first switching element M1, the second switching element M2 and the first inductor L1.

The first switching controller 140 may control the first and second switching elements M1 and M2, respectively.

Particularly, the first switching controller 140 controls on/off operations of the first and second switching elements M1 and M2, respectively, according to the switching frequency, so that the input voltage Vin can be converted into the first voltage ELVSS having a desired voltage level.

In this case, the first and second switching elements M1 and M2, respectively, may be alternately turned on.

The first and second switching elements M1 and M2, respectively, may be implemented as transistors.

The first and second switching elements M1 and M2, respectively, may be implemented as transistors having different conductive types for convenience of controlling the transistors. For example, in a case where the first switching element M1 is implemented as an n-type transistor, the second switching element M2 may be implemented as a p-type transistor.

The first switching controller 140 may change the switching frequency by reflecting the first voltage ELVSS outputted through the first output terminal OUT1.

For example, in a case where the amplitude of the first voltage ELVSS increases, the first switching controller 140 may increase the switching frequency by deciding that the capacity of the load increases.

In a case where the amplitude of the first voltage ELVSS decreases, the first switching controller 140 may decrease the switching frequency by deciding that the capacity of the load decreases.

To this end, the first switching regulator 61 may further include a control voltage generator 120 and a voltage controlled oscillator 130.

The control voltage generator 120 may generate a control voltage Vcon, using the difference between a feedback voltage Vfb reflecting the first voltage ELVSS and a reference voltage Vref.

The control voltage generator 120 may supply the generated control voltage Vcon to the voltage controlled oscillator 130.

In this case, the level of the control voltage Vcon may be changed depending on the difference of the feedback voltage Vfb reflecting the first voltage ELVSS and the reference voltage Vref.

The feedback voltage Vfb may be generated from a voltage divider 110 that divides the first voltage ELVSS of the first output terminal OUT1.

The voltage divider 110 may be configured with a plurality of resistors R1 and R2 coupled to the first output terminal OUT1.

The voltage controlled oscillator 130 generates a clock signal CLK having a frequency changed depending on the control voltage Vcon supplied from the control voltage generator 120, and supplies the generated clock signal CLK to the first switching controller 140.

That is, the frequency of the clock signal CLK may be changed depending on the level of the control voltage Vcon.

The frequency of the clock signal CLK is changed while avoiding the scan frequency of the scan driver 30 and the harmonic frequency of the scan frequency.

In this case, the first switching controller 140 that receives the clock signal CLK may control the switching frequency in synchronization of the frequency of the clock signal CLK.

Thus, the switching frequency of the first switching regulator 61 can be synchronized with the frequency of the clock signal CLK.

As a result, the switching frequency can be changed depending on the capacity of the load through the configuration described above, thereby increasing the power conversion efficiency of the first switching regulator 61.

Furthermore, the scan frequency of the scan driver 30 and the harmonic frequency of the scan frequency can be avoided, thereby reducing the flicker phenomenon.

The second switching regulator 62 converts the input voltage Vin into the second voltage ELVDD, and supplies the second voltage ELVDD to each pixel 10.

Referring to FIG. 3, the second switching regulator 62 may include a second inductor L2, a third switching element M3, a fourth switching element M4 and a second switching controller 240.

The second inductor L2 may be coupled between a second node N2 and a second input terminal IN2 through which the input voltage Vin is applied to the second inductor L2.

The third switching element M3 may be coupled between the second node N2 and the ground.

The fourth switching element M4 may be coupled between the second node N2 and a second output terminal OUT2 through which the second voltage ELVDD is output.

In this case, the second node N2 may be defined as a common node of the second inductor L2, the third switching element M3 and the fourth switching element M4.

The second switching controller 240 may control the third and fourth switching elements M3 and M4.

The second switching controller 240 controls on/off operations of the third and fourth switching elements M3 and M4, so as to convert the input voltage Vin into the second voltage ELVDD having a desired voltage level.

In this case, the third and fourth switching elements M3 and M4 may be alternately turned on.

The third and fourth switching elements M3 and M4 may be implemented as transistors.

The third and fourth switching elements M3 and M4 may be implemented as transistors having different conductive types for convenience of controlling the transistors. For example, in a case where the third switching element M3 is implemented as a p-type transistor, the fourth switching element M4 may be implemented as an n-type transistor.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display, comprising:
a plurality of pixels coupled to scan lines and data lines;
a scan driver that supplies a scan signal to the pixels through the scan lines according to a predetermined scan frequency;
a data driver that supplies a data signal to the pixels through the data lines; and
a first switching regulator that supplies a first voltage to the pixels and has a changeable switching frequency;
the switching frequency of the first switching regulator being changed while avoiding the scan frequency of the scan driver.

2. The organic light emitting display according to claim 1, the switching frequency of the first switching regulator being changed while avoiding the scan frequency and a harmonic frequency of the scan frequency.

3. The organic light emitting display according to claim 1, the first switching regulator comprising:
a first switching element coupled between a first node and a first input terminal through which an input voltage is applied to the first switching element;
a second switching element coupled between the first node and a first output terminal through which the first voltage is outputted;
a first inductor coupled between the first node and a ground; and
a first switching controller that controls the first and second switching elements according to the switching frequency.

4. The organic light emitting display according to claim 3, the switching controller changing the switching frequency by reflecting the first voltage.

5. The organic light emitting display according to claim 4, the first switching regulator further comprising:
a control voltage generator that generates a control voltage using the difference between a reference voltage and a feedback voltage reflecting the first voltage; and
a voltage controlled oscillator that generates a clock signal having a frequency changed depending on the control voltage.

6. The organic light emitting display according to claim 5, the first switching controller controlling the switching frequency in synchronization with the frequency of the clock signal supplied from the voltage controlled oscillator.

7. The organic light emitting display according to claim 5, the first switching regulator further comprising a voltage divider that generates the feedback voltage by dividing the first voltage of the first output terminal.

8. The organic light emitting display according to claim 3, the first and second switching elements being implemented as transistors.

9. The organic light emitting display according to claim 1, the first voltage being a negative voltage.

10. The organic light emitting display according to claim 3, the first and second switching elements being alternately turned on.

11. The organic light emitting display according to claim 1, further comprising a second switching regulator that supplies a second voltage to the pixels.

12. The organic light emitting display according to claim 11, the second switching regulator comprising:
a second inductor coupled between a second node and a second input terminal through which the input voltage is applied to the second inductor;
a third switching element coupled between the second node and the ground;
a fourth switching element coupled between the second node and a second output terminal through which the second voltage is outputted; and
a second switching controller that controls the third and fourth switching elements.

13. The organic light emitting display according to claim 12, the third and fourth switching elements being implemented as transistors.

14. The organic light emitting display according to claim 12, the third and fourth switching elements being alternately turned on.
